(19) United States
(12) Patent Application Publication
(10) Pub. No.: US 2018/0184305 A1
(43) Pub. Date: Jun. 28, 2018

(54) Fast and Flexible Deployment of User Equipment-Based Relay

(71) Applicant: Nokia Solutions and Networks Oy, Espoo (FI)

(72) Inventors: Tie SHEN, Beijing (CN); Jing Xiu LIU, Beijing (CN); Yan CHEN, Beijing (CN)

(21) Appl. No.: 15/738,231

(22) PCT Filed: Jun. 30, 2015
(86) PCT No.: PCT/CN2015/082905

§ 371 Date: Dec. 20, 2017

(51) Int. Cl. H04W 16/26

(52) U.S. Cl. CPC H04W 16/26; H04W 84/047

(57) ABSTRACT

Fast and flexible deployment of user equipment-based relays are disclosed. Numerous communication systems may benefit from appropriate use of relays. For example, certain wireless communication systems may benefit from fast and flexible deployment of user equipment based relays. A method can include determining that a relay is to be set up for at least one user equipment. The method can also include setting up an access point name on a first core network element for the relay. The access point name can be configured to access an address of a second core network element.

### BACKGROUND

### Field

Numerous communication systems may benefit from appropriate use of relays. For example, certain wireless communication systems may benefit from fast and flexible deployment of user equipment based relays.

### Description of the Related Art

Various kinds of relay are discussed in wireless communication, before and after the specification and launch of long term evolution (LTE)/LTE Advanced (LTE-A). Generally relay can be categorized into: L1 relay, L2 relay and L3 relay, corresponding to the different protocol architecture in the relay node. L3 relay is discussed and defined in the Third Generation Partnership Project (3GPP), for both frequency division duplex (FDD) and time division duplex (TDD).

LTE and LTE-A have been launched world-widely and quickly in recent years, with macro base station as the major outdoor deployment solution. 3GPP defined so-called in-band relay, which means the link between a donor eNB and relay and the link between the relay and UE share the same frequency resource. Such sharing can make the air interface protocol very complex and may involve a protocol update in core. Since relay is not the majority scenario in customer network, it may not be feasible to update the whole region network so as to support a few relays. The updating for such cases may involve core network (CN) updates and radio access network (RAN) updates, including updates to evolved Node B (eNB), mobility management entity (MME), home subscriber server (HSS), and operations support system (OSS). Furthermore, the Internet of Things (IoT) between any two updated network elements may need to be updated, which may be complicated in a multi-vendor case.

One option is to use a combined small cell and relay customer premises equipment (CPE) working together as relay. The customer premises equipment may be customer provided equipment. This approach of using a combined small cell and CPE may not have any impact on the evolved packet core (EPC), but may need an eNB update. In such an approach there may be no relay related S1 link from MME/S-GW perspective, which have been resolved and aggregated into the S1 link of eNB. Thus, there may be a very close interdependency between EPC and eNB.

### SUMMARY

According to certain embodiments, a method can include determining that a relay is to be set up for at least one user equipment. The method can also include setting up an access point name on a first core network element for the relay. The access point name can be configured to access an address of a second core network element.

In certain embodiments, a method can include determining that a relay has been set up on a first core network element for at least one user equipment. The method can also include assigning, at a second core network element, at least one static internet protocol address and access point name for a customer premises equipment in the relay. The internet protocol address can be selected to belong to a same range as an address of the relay set up on the first core network element.

An apparatus, according to certain embodiments, can include at least one processor and at least one memory including computer program code. The at least one memory and the computer program code can be configured to, with the at least one processor, cause the apparatus at least to determine that a relay is to be set up for at least one user equipment. The at least one memory and the computer program code can also be configured to, with the at least one processor, cause the apparatus at least to set up an access point name on a first core network element for the relay. The access point name can be configured to access an address of a second core network element.

An apparatus, in certain embodiments, can include at least one processor and at least one memory including computer program code. The at least one memory and the computer program code can be configured to, with the at least one processor, cause the apparatus at least to determine that a relay has been set up on a first core network element for at least one user equipment. The at least one memory and the computer program code can also be configured to, with the at least one processor, cause the apparatus at least to assign, at a second core network element, at least one static internet protocol address and access point name for a customer premises equipment in the relay. The internet protocol address can be selected to belong to a same range as an address of the relay set up on the first core network element.

According to certain embodiments, an apparatus can include means for determining that a relay is to be set up for at least one user equipment. The apparatus can also include means for setting up an access point name on a first core network element for the relay, wherein the access point name is configured to access an address of a second core network element.

In certain embodiments, an apparatus can include means for determining that a relay has been set up on a first core network element for at least one user equipment. The apparatus can also include means for assigning, at a second core network element, at least one static internet protocol address and access point name for a customer premises equipment in the relay, wherein the internet protocol address is selected to belong to a same range as an address of the relay set up on the first core network element.

A non-transitory computer-readable medium can, according to certain embodiments, be encoded with instructions that, when executed in hardware, perform a process. The process can be any of the above-described methods.

A computer program product can, in certain embodiments, encode instructions for performing a process. The process can be any of the above-described methods.

### BRIEF DESCRIPTION OF THE DRAWINGS

For proper understanding of the invention, reference should be made to the accompanying drawings, wherein:

FIG. 1 illustrates a system architecture according to certain embodiments.

FIG. 2 illustrates an implementation in a core network, according to certain embodiments.

FIG. 3 illustrates communication paths supporting relay, according to certain embodiments.

FIG. 4 illustrates operations and maintenance configuration according to certain embodiments.

FIG. 5 illustrates a method according to certain embodiments.

FIG. 6 illustrates a system according to certain embodiments.

### DETAILED DESCRIPTION

Certain embodiments may permit flexible deployment of relay systems. Such flexible deployment may provide additional coverage and capacity boost, with minimal impact to existing network and in-service subscribers.

Further embodiments may address mobile relay, which currently is not defined by 3GPP. Mobile relay may be used for, for example, any event wherein there is a need for extra network capacity, such as a mass event like a music festival/sport match, at the main-gate or parking for temporary coverage. Furthermore, mobile relay may be used for emergency communication or in other scenarios.

As noted above, 3GPP defined in-band relay. This in-band relay may be configured to manage interference effectively and efficiently, based on the assumption of full buffer traffic model. In practice, however, the network is not always jammed with a high traffic load. Thus, sub-optimal relay solutions may be tempting to provide short term coverage.

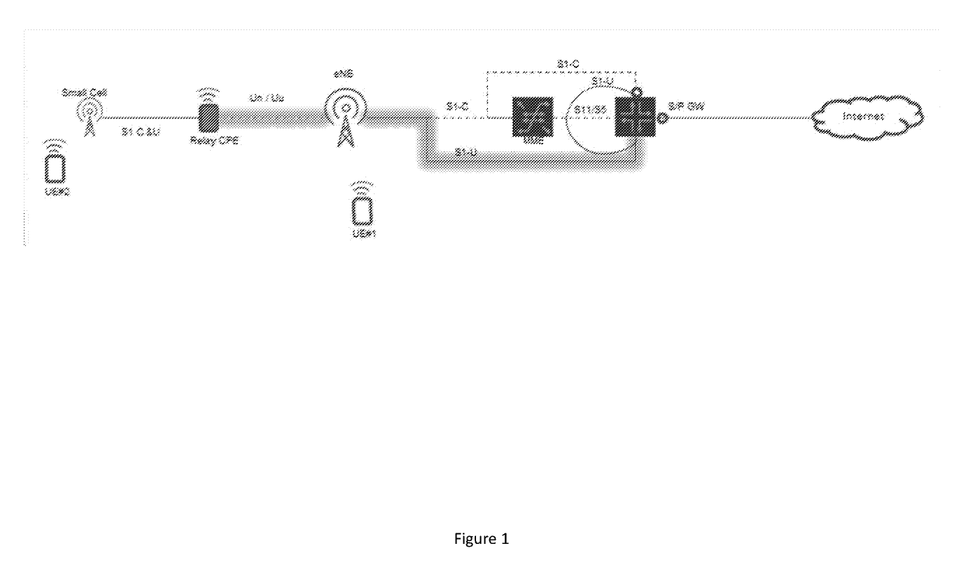

Various embodiments can provide systems and methods for relay based on user equipment (UE). FIG. 1 illustrates a system architecture according to certain embodiments.

As shown in FIG. 1, a served user equipment UE#2 can be supported by a relay that includes a small cell and relay customer premises equipment (CPE), to relay a signal from an evolved Node B (eNB). The eNB in FIG. 1 can be a general long term evolution (LTE) base station, regardless of whether it is frequency division duplex (FDD) or time division duplex (TDD), and can be provided by any desired vendor.

Interface S1-U can be provided via the eNB between the relay CPE and a serving and/or packet data network (PDN) gateway (S-GW/P-GW or S/P GW). Interface S1-C can provided between a mobility management entity (MME) and the S/P GW. Furthermore, S1-U can be provided referring back to S/P GW. These interfaces, S1-U, S1-C, and so on are example interfaces. The same principles may be applied to other interfaces.

The relay CPE can be a commercial CPE and the small cell can be a commercial small cell base station, whether TDD or FDD, and from any vendor. The relay CPE can provide the backhaul to/from eNB, and the small cell can provide the fronthaul to/from user equipment. The relay CPE and the small cell together can function as the UE-based relay. The relay CPE, eNB, and small cell can be variously connected, such as by Ethernet, fiber, wireless, or any combination thereof.

The MME and serving gateway can be evolved packet core (EPC) core network elements. In this example, UE#1 can be served by eNB, while UE2 can be served by relay. The small cell and commercial CPE can together provide the relay function.

Certain embodiments can provide a method to configure EPC core network so that the UE under the coverage of relay can setup S1 link successfully. This method can include the setup of one additional access point name (APN) on an EPC P-GW, which is dedicated for relay. This APN can access the internet protocol (IP) address of an EPC core node. For the UE served by relay, the IP address can follow the same process as a normal UE, which can be assigned by a normal APN.

The home subscriber server (HSS) can assign a static IP address and APN for the CPE IMSI in the relay, and this IP address belongs to the same IP address range as the IP address of the relay APN defined on the P-GW. This IP address assigned by the HSS can be bridged from the CPE to the small cell, and the small cell can use this IP address as the IP address of S1-C/S1-U/S1-M, or any combination of those interfaces.

There may be various ways to implement certain embodiments. In general, the implementation can be described in terms of implementation in an EPC core network, implementation in operations and maintenance (O&M) configuration, and implementation in radio access network (RAN).

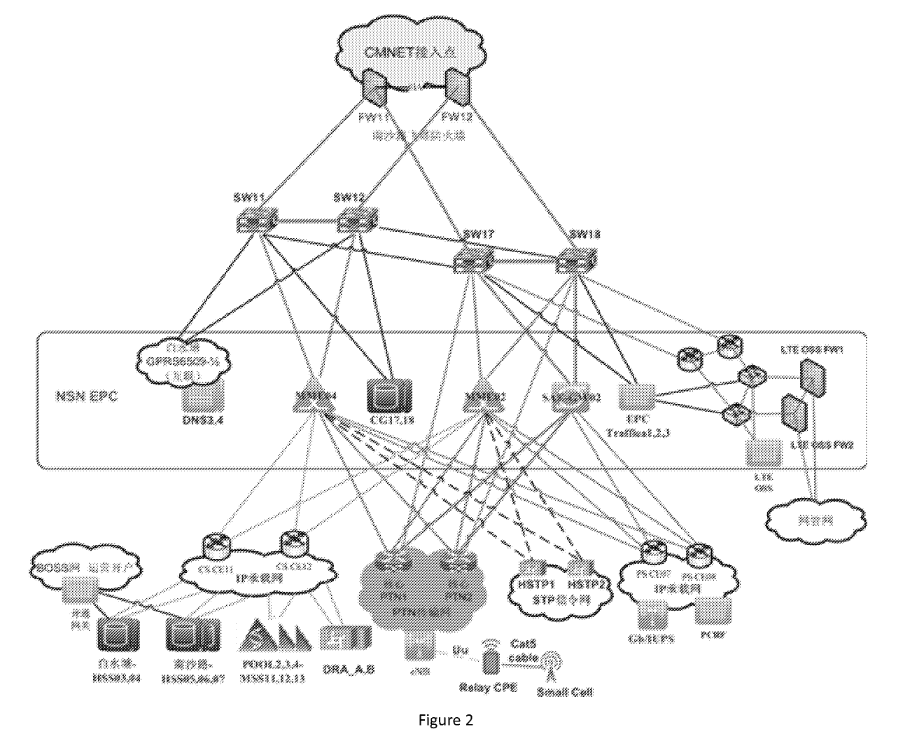

FIG. 2 illustrates an implementation in a core network, according to certain embodiments. For relay, the end to end (e2e) connection can include the following links: a small cell connected via an Ethernet cable (for example, a category 5 (Cat5) cable) to a relay CPE; the relay CPE connected by interface Uu to an LTE eNB; the LTE eNB connected by a fiber cable to an access point of packet transport network (PTN); and aggregation of the Access PTN can connect further to a core site PTN, which can connect to an evolved packet core (EPC), on which MME02/SAEGW02 can reside. These are examples and other connections possible, for example a small cell can also use a fiber or wireless connection.

Certain embodiments can help setup an S1 link for subscribers under the coverage of a relay. This process may have various challenges.

As shown in FIG. 1, UE#1 served by eNB, may be able to setup S1 link to MME and S-GW directly and normally, including both S1-C and S1-U, corresponding to S1 control plane message and S1 user plane message. Thus, such a user equipment may be easily handled.

However, for UE#2 in FIG. 1, which is served by relay, both S1-U and S1-C of UE#2 may be sent from Small cell to Relay CPE on Uu/Un interface, which means Relay CPE and eNB will treat both S1-U and S1-C of UE#1 as raw data and send them to S-GW. Thus, from ECP perspective, only S1-U of UE#2 can be resolved by S-GW, but S1-C information of UE#2 is not available at a mobility management entity (MME) at all. So UE#2 S1 link setup may fail.

Thus, the implementation method at EPC side can include the following. For relay S1 realization at the EPC core side, the system can add a relay APN IP pool at SAEGW02, which can assign a static IP address to a Relay CPE. The relay IP route can come out from interface Sgi of SAEGW02 to SW 17/18 (EPC core switch 7609), connect SW 17/18 with Core PTN and can add IP rout on 7609 to MME02 and SAEGW02 S1 port.

Furthermore, for X2 IP rout realization, the system can add an IP rout on Core PTN for Relay CPE IP address to MME02 to connect Relay Small Cell with other LTE eNB.

Additionally, a dedicated user profile can be added on HSS for Relay SIM with a relay dedicated APN (eg. Relay.HQ). The HSS can also configure a static IP address. The IP address can be in the Relay IP pool in SAEGW02. While a static IP may make the maintenance of a really Small Cell easier, the same approach can be applied with a dynamic IP, for example one selected from a fixed pool. The system can also add domain name service (DNS) resolution of Relay.HQ to SEAGW02 in a DNS server.

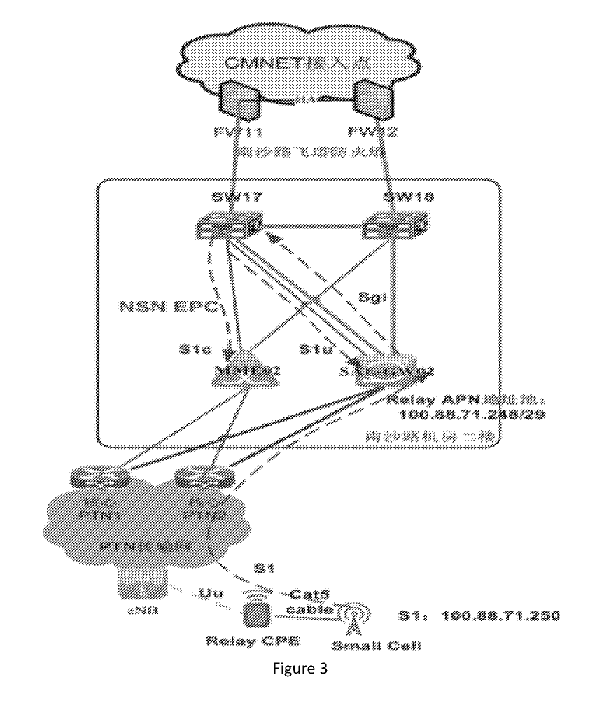

FIG. 3 illustrates communication paths supporting relay, according to certain embodiments. As shown in FIG. 3, SW17 Sgi interface can be in vrfcmnet VPN domain, while other interfaces on SW17 can be in default rout domain. Thus, to realize the relay S1c and S1u from Sgi to MME02 and SEAGW02, a sub interface or a new fiber connection on SW17 can be added to MME/SAEGW and banding vrfcmnet.

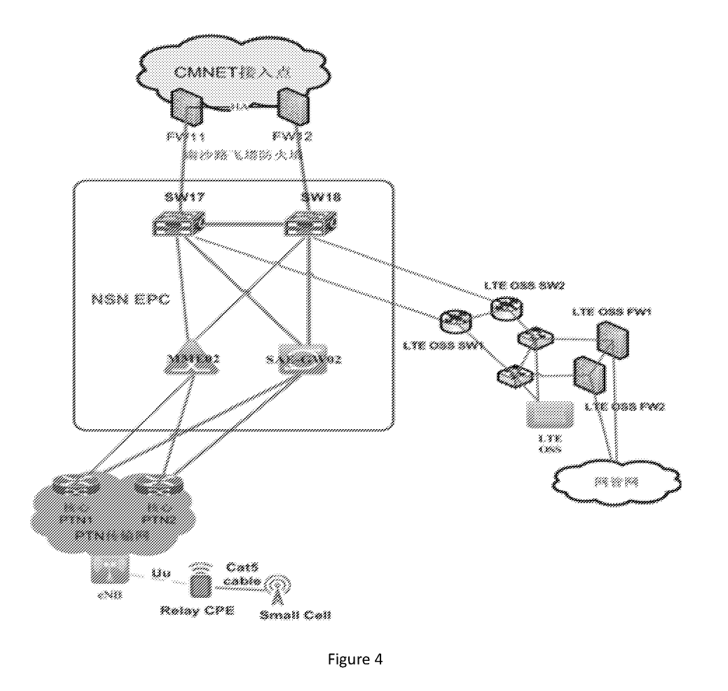

As mentioned above, implementation can also involve O&M configuration. FIG. 4 illustrates operations and maintenance configuration according to certain embodiments.

As shown in FIG. 4, to use relay service IP for maintenance, a rout can be added from SW17/18 to LTE operations systems support (OSS). As shown in FIG. 4, the rout can be to particular LTE OSS switches (LTE OSS SW1, LTE OSS SW2), and the OSS network can further implement communications to the LTE or other systems.

Additionally, as mentioned above, certain embodiments can also involve implementation in a radio access network (RAN). As can be seen from the preceding figures and description, a combination of Small Cell and Relay CPE can function as a UE-based relay. The relay CPE can provide an S1 IP address for the Small Cell by bridge mode.

The Small Cell and Donor eNB can use different absolute radio frequency channel numbers (ARFCNs) to avoid interference. Nevertheless, this use of different ARFCNs may not be enforced, and consequently may, in some cases, not be applied. Thus, it may be possible that the small cell and donor eNB can be using the same ARFCN. This may be accomplished by, for example, avoiding interference in other ways, such as RF planning to avoid interference, for example directional antenna, tilting adjustment, and the like.

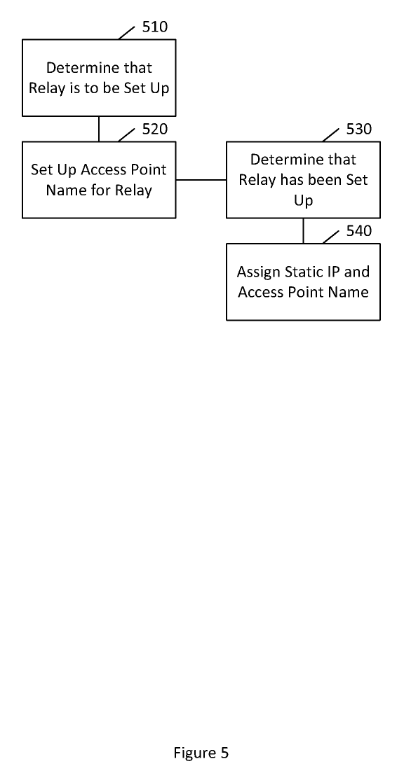

FIG. 5 illustrates a method according to certain embodiments. As shown in FIG. 5, a method can include, at 510, determining that a relay is to be set up for at least one user equipment. This determination may be made in a core network element based on information provided from, for example, a radio access network element.

The method can also include, at 520, setting up an access point name on a first core network element for the relay, wherein the access point name is configured to access an address of a second core network element.

The first core network element can be a packet data network gateway, a serving gateway, or any combination thereof. For example, in certain embodiments the first core network element may be a system architecture evolution (SAE) gateway. Other embodiments are possible.

The access point name can be assigned an address in a same range as customer premises equipment for the relay for the at least one user equipment. As mentioned above, such selection may simplify management.

The second core network element can be a mobility management entity, a packet data network gateway, a serving gateway, or other core network element.

The method can further include, at 530, determining that a relay has been set up on a first core network element for at least one user equipment. This can be a determination that the relay has begun to be set up, without requiring that the relay be completely set up. This setting up of the relay can correspond to the setting up of the access point name at 520.

The method can additionally include, at 540, assigning, at a second core network element, at least one static internet protocol address and access point name for a customer premises equipment in the relay. The internet protocol address can be selected to belong to a same range as an address of the relay set up on the first core network element.

As mentioned above, the first core network element can be, for example, a packet data network gateway or a serving gateway. The second network element, by contrast, can be, for example, a mobility management entity or a home subscriber server.

The static internet protocol address for the customer premises equipment can be configured to be bridged to a small cell of the relay. Additionally, the static internet protocol address for the customer premises equipment can be configured to be used as an address for S1-C, S1-U, S1-M, or any combination of S1-C, S1-U, and S1-M. Thus, for example, the core network may be able to recognize and properly handle an S1 interface to a relayed user equipment.

The range of IP addresses mentioned above can be a predefined pool of internet protocol addresses reserved for relays. Other possible ranges are also permitted.

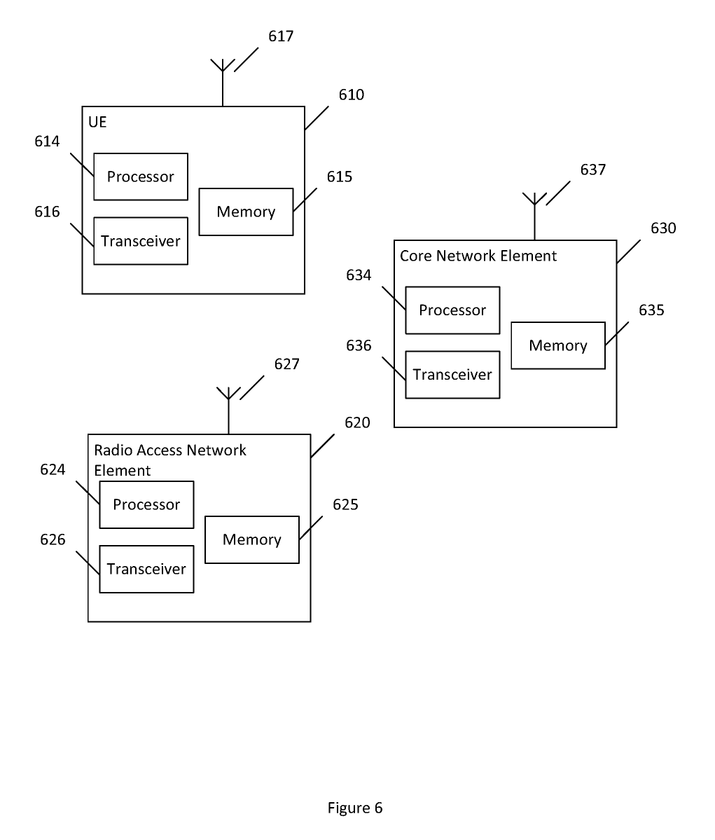

FIG. 6 illustrates a system according to certain embodiments of the invention. In one embodiment, a system may include multiple devices, such as, for example, at least one UE 610, at least one radio access network element 620, which may be an eNB or other base station or access point, and at least one core network element 630, which may be a packet data network (PDN) gateway (P-GW), serving gateway (S-GW), HSS, MME, or any other core network element shown or described herein (see, for example, FIGS. 1-4).

Each of these devices may include at least one processor, respectively indicated as 614, 624, and 634. At least one memory can be provided in each device, and indicated as 615, 625, and 635, respectively. The memory may include computer program instructions or computer code contained therein. The processors 614, 624, and 634 and memories 615, 625, and 635, or a subset thereof, can be configured to provide means corresponding to the various blocks of FIG. 5.

As shown in FIG. 6, transceivers 616, 626, and 636 can be provided, and each device may also include an antenna, respectively illustrated as 617, 627, and 637. Other configurations of these devices, for example, may be provided. For example, core network element 630 may be configured solely for wired communication, rather than wireless communication, and in such a case antenna 637 can illustrate any form of communication hardware, such as a network interface card, without requiring a conventional antenna.

Transceivers 616, 626, and 636 can each, independently, be a transmitter, a receiver, or both a transmitter and a receiver, or a unit or device that is configured both for transmission and reception.

Processors 614, 624, and 634 can be embodied by any computational or data processing device, such as a central processing unit (CPU), application specific integrated circuit (ASIC), or comparable device. The processors can be implemented as a single controller, or a plurality of controllers or processors.

Memories 615, 625, and 635 can independently be any suitable storage device, such as a non-transitory computer-readable medium. A hard disk drive (HDD), random access memory (RAM), flash memory, or other suitable memory can be used. The memories can be combined on a single integrated circuit as the processor, or may be separate from the one or more processors. Furthermore, the computer program instructions stored in the memory and which may be processed by the processors can be any suitable form of computer program code, for example, a compiled or interpreted computer program written in any suitable programming language.

The memory and the computer program instructions can be configured, with the processor for the particular device, to cause a hardware apparatus such as UE 610, radio access network element 620, and core network element 630, to perform any of the processes described herein (see, for example, FIG. 5). Therefore, in certain embodiments, a non-transitory computer-readable medium can be encoded with computer instructions that, when executed in hardware, perform a process such as one of the processes described herein. Alternatively, certain embodiments of the invention can be performed entirely in hardware.

Furthermore, although FIG. 6 illustrates a system including a UE, radio access network element, and core network element, embodiments of the invention may be applicable to other configurations, and configurations involving additional elements. For example, not shown, additional UEs may be present, and additional radio access network elements and core network elements may be present, as illustrated in FIGS. 1-4.

Certain embodiments may have various benefits and/or advantages. For example, certain embodiments can support inter-vendor configuration, meaning EPC, eNB, CPE, and small cell can all be from different vendors and the configurations can be highly flexible. Furthermore, certain embodiments can support both in-band configuration (same frequency for eNB-Relay and Relay-UE) and out-band (different frequency for eNB-Relay and Relay-UE) configuration.

Furthermore, certain embodiments can support different FDD LTE and TDD LTE as either eNB-Relay and Relay-UE links. Additionally, certain embodiments can support inter-radio access technology (RAT) relay system, conditioned with Ethernet as an interface between small cell and CPE, for example global system for mobile communication (GSM)/time division synchronous code division multiple access (TD-SCDMA)/wideband code division multiple access (WCDMA) as the RAT for relay-UE, LTE as the RAT for eNB-relay.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A method, comprising:
determining that a relay is to be set up for at least one user equipment; and
setting up an access point name on a first core network element for the relay, wherein the access point name is configured to access an address of a second core network element.

2. The method of claim 1, wherein the first core network element comprises at least one of a packet data network gateway or a serving gateway.

3. The method of claim 1, wherein the access point name is assigned an address in a same range as customer premises equipment for the relay for the at least one user equipment.

4. The method of claim 1, wherein the second core network element comprises at least one of a mobility management entity, a packet data network gateway, or a serving gateway.

5. A method, comprising:
determining that a relay has been set up on a first core network element for at least one user equipment; and
assigning, at a second core network element, at least one static internet protocol address and access point name for a customer premises equipment in the relay, wherein the internet protocol address is selected to belong to a same range as an address of the relay set up on the first core network element.

6. The method of claim 5, wherein the first core network element comprises at least one of a packet data network gateway or a serving gateway.

7. The method of claim 5, wherein the second network element comprises at least one of a mobility management entity or a home subscriber server.

8. The method of claim 5, wherein the static internet protocol address for the customer premises equipment is configured to be bridged to a small cell of the relay.

9. The method of claim 8, wherein the static internet protocol address for the customer premises equipment is configured to be used as an address for S1-C, S1-U, S1-M, or any combination of S1-C, S1-U, and S1-M.

10. (canceled)

11. An apparatus, comprising:
at least one processor; and
at least one memory including computer program code,
wherein the at least one memory and the computer program code are configured to, with the at least one processor, cause the apparatus at least to
determine that a relay is to be set up for at least one user equipment; and
set up an access point name on a first core network element for the relay, wherein the access point name is configured to access an address of a second core network element.

12. The apparatus of claim 11, wherein the first core network element comprises at least one of a packet data network gateway or a serving gateway.

13. The apparatus of claim 11, wherein the access point name is assigned an address in a same range as customer premises equipment for the relay for the at least one user equipment.

14. The apparatus of claim 11, wherein the second core network element comprises at least one of a mobility management entity, a packet data network gateway, or a serving gateway.

15. An apparatus, comprising:
at least one processor; and
at least one memory including computer program code,
wherein the at least one memory and the computer program code are configured to, with the at least one processor, cause the apparatus at least to
determine that a relay has been set up on a first core network element for at least one user equipment; and
assign, at a second core network element, at least one static internet protocol address and access point name for a customer premises equipment in the relay, wherein the internet protocol address is selected to belong to a same range as an address of the relay set up on the first core network element.

16. The apparatus of claim 15, wherein the first core network element comprises at least one of a packet data network gateway or a serving gateway.

17. The apparatus of claim 15, wherein the second network element comprises at least one of a mobility management entity or a home subscriber server.

18. The apparatus of claim 15, wherein the static internet protocol address for the customer premises equipment is configured to be bridged to a small cell of the relay.

19. The apparatus of claim 18, wherein the static internet protocol address for the customer premises equipment is configured to be used as an address for S1-C, S1-U, S1-M, or any combination of S1-C, S1-U, and S1-M.

20. The apparatus of claim 15, wherein the range comprises a predefined pool of internet protocol addresses reserved for relays.

21.-30. (canceled)

31. A computer program product comprising a non-transitory computer-readable medium encoded with instructions that, when executed in hardware, cause the hardware to perform a process, the process comprising the method according to claim 1.

32. (canceled)
